(19) United States
(12) Patent Application Publication
(10) Pub. No.: US 2002/0055361 A1
(43) Pub. Date: May 9, 2002

(54) Location-based equipment control

(76) Inventors: James Thomas Edward McDonnell, Bristol (GB); Andrew Thomas, Atherton, CA (US); John Deryk Waters, Combe Down (GB); Simon Edwin Crouch, Stoke Bishop (GB); Paul Vickers, Clevedon (GB)

Correspondence Address: LADAS & PARRY, Suite 2100, 5670 Wilshire Boulevard, Los Angeles, CA, 90036-5679, US

(21) Appl. No.: 09/862,184

(22) Filed: May 21, 2001

(30) Foreign Application Priority Data
May 24, 2000 (GB) 0012445.3

(51) Int. Cl. H04Q 7/20

(52) U.S. Cl. 455/456; 455/410

(57) ABSTRACT

Particular functionality of an item of equipment (70) is enabled upon both a location condition and a personnel condition being satisfied. The location condition is tested for by obtaining current-location data (67) representing the current location of the equipment, and comparing the current-location data with authorized-location data representing a predetermined authorized location or locality for operation of the equipment functionality. The personnel condition is tested for by checking for the presence at or near the equipment of at least one person (77) fitting stored authorized-personnel data (42) that identifies specified person or persons, or a specified grade of person. The location and personnel conditions can be tested for at the equipment (70) or at a remote service system (40).

### FIELD OF THE INVENTION

The present invention relates to the enabling of equipment functionality in dependence on the fulfillment of predetermined conditions, including a location condition.

### BACKGROUND OF THE INVENTION

Communication infrastructures suitable for mobile users (in particular, though not exclusively, cellular radio infrastructures) have now become widely adopted. Whilst the primary driver has been mobile telephony, the desire to implement mobile data-based services over these infrastructures, has led to the rapid development of data-capable bearer services across such infrastructures. This has opened up the possibility of many Internet-based services being available to mobile users.

By way of example, FIG. 1 shows one form of known communication infrastructure for mobile users providing both telephony and data-bearer services. In this example, a mobile entity 20, provided with a radio subsystem 22 and a phone subsystem 23, communicates with the fixed infrastructure of GSM PLMN (Public Land Mobile Network) 10 to provide basic voice telephony services. In addition, the mobile entity 20 includes a data-handling subsystem 25 interworking, via data interface 24, with the radio subsystem 22 for the transmission and reception of data over a data-capable bearer service provided by the PLMN; the data-capable bearer service enables the mobile entity 20 to communicate with a service system 40 connected to the public Internet 39. The data handling subsystem 25 supports an operating environment 26 in which applications run, the operating environment including an appropriate communications stack.

More particularly, the fixed infrastructure 10 of the GSM PLMN comprises one or more Base Station Subsystems (BSS) 11 and a Network and Switching Subsystem NSS 12. Each BSS 11 comprises a Base Station Controller (BSC) 14 controlling multiple Base Transceiver Stations (BTS) 13 each associated with a respective “cell” of the radio network. When active, the radio subsystem 22 of the mobile entity 20 communicates via a radio link with the BTS 13 of the cell in which the mobile entity is currently located. As regards the NSS 12, this comprises one or more Mobile Switching Centers (MSC) 15 together with other elements such as Visitor Location Registers 32 and Home Location Register 32.

When the mobile entity 20 is used to make a normal telephone call, a traffic circuit for carrying digitised voice is set up through the relevant BSS 11 to the NSS 12 which is then responsible for routing the call to the target phone (whether in the same PLMN or in another network).

With respect to data transmission to/from the mobile entity 20, in the present example three different data-capable bearer services are depicted though other possibilities exist. A first data-capable bearer service is available in the form of a Circuit Switched Data (CSD) service; in this case a full traffic circuit is used for carrying data and the MSC 32 routes the circuit to an InterWorking Function IWF 34 the precise nature of which depends on what is connected to the other side of the IWF. Thus, IWF could be configured to provide direct access to the public Internet 39 (that is, provide functionality similar to an IAP—Internet Access Provider IAP). Alternatively, the IWF could simply be a modem connecting to a PSTN; in this case, Internet access can be achieved by connection across the PSTN to a standard IAP.

A second, low bandwidth, data-capable bearer service is available through use of the Short Message Service that passes data carried in signalling channel slots to an SMS unit which can be arranged to provide connectivity to the public Internet 39.

A third data-capable bearer service is provided in the form of GPRS (General Packet Radio Service which enables IP (or X.25) packet data to be passed from the data handling system of the mobile entity 20, via the data interface 24, radio subsystem 21 and relevant BSS 11, to a GPRS network 17 of the PLMN 10 (and vice versa). The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the mobile entity 20 can exchange packet data via the BSS 11 and GPRS network 17 with entities connected to the public Internet 39.

The data connection between the PLMN 10 and the Internet 39 will generally be through a firewall 35 with proxy and/or gateway functionality.

Different data-capable bearer services to those described above may be provided, the described services being simply examples of what is possible.

In FIG. 1, a service system 40 is shown connected to the Internet 40, this service system being accessible to the OS/application 26 running in the mobile entity by use of any of the data-capable bearer services described above. The data-capable bearer services could equally provide access to a service system that is within the domain of the PLMN operator or is connected to another public or private data network.

With regard to the OS/application software 26 running in the data handling subsystem 25 of the mobile entity 20, this could, for example, be a WAP application running on top of a WAP stack where “WAP” is the Wireless Application Protocol standard. Details of WAP can be found, for example, in the book “Official Wireless Application Protocol” Wireless Application Protocol Forum, Ltd published 1999 Wiley Computer Publishing. Where the OS/application software is WAP compliant, the firewall will generally also serve as a WAP proxy and gateway. Of course, OS/application 26 can comprise other functionality (for example, an e-mail client) instead of, or additional to, the WAP functionality.

The mobile entity 20 may take many different forms. For example, it could be two separate units such as a mobile phone (providing elements 22-24) and a mobile PC (data-handling system 25) coupled by an appropriate link (wireline, infrared or even short range radio system such as Bluetooth). Alternatively, mobile entity 20 could be a single unit such as a mobile phone with WAP functionality. Of course, if only data transmission/reception is required (and not voice), the phone functionality 24 can be omitted; an example of this is a PDA with built-in GSM data-capable functionality whilst another example is a digital camera (the data-handling subsystem) also with built-in GSM data-capable functionality enabling the upload of digital images from the camera to a storage server.

Whilst the above description has been given with reference to a PLMN based on GSM technology, it will be appreciated that many other cellular radio technologies exist and can typically provide the same type of functionality as described for the GSM PLMN 10.

Recently, much interest has been shown in “location-based”, “location-dependent”, or “location-aware” services for mobile users, these being services that take account of the current location of the user (or other mobile party). The most basic form of this service is the emergency location service whereby a user in trouble can press a panic button on their mobile phone to send an emergency request-for-assistance message with their location data appended. Another well known location-based service is the provision of traffic and route-guiding information to vehicle drivers based on their current position. A further known service is a “yellow pages” service where a user can find out about amenities (shops, restaurants, theatres, etc.) local to their current location. The term “location-aware services” will be used herein to refer generically to these and similar services where a location dependency exists.

Location-aware services all require user location as an input parameter. A number of methods already exist for determining the location of a mobile user as represented by an associated mobile equipment. Example location-determining methods will now be described with reference to FIGS. 2 to 5. As will be seen, some of these methods result in the user knowing their location thereby enabling them to transmit it to a location-aware service they are interested in receiving, whilst other of the methods result in the user's location becoming known to a network entity from where it can be supplied directly to a location-aware service (generally only with the consent of the user concerned). It is to be understood that additional methods to those illustrated in FIGS. 2 to 5 exist.

As well as location determination, FIGS. 2 to 5 also illustrate how the mobile entity requests a location-aware service provided by service system 40. In the present examples, the request is depicted as being passed over a cellular mobile network (PLMN 10) to the service system 40. The PLMN is, for example, similar to that depicted in FIG. 1 with the service request being made using a data-capable bearer service of the PLMN. The service system 40 may be part of the PLMN itself or connected to it through a data network such as the public Internet. It should, however, be understood that infrastructure other than a cellular network may alternatively be used for making the service request

The location-determining method illustrated in FIG. 2 uses an inertial positioning system 50 provided in the mobile entity 20A, this system 50 determining the displacement of the mobile entity from an initial reference position. When the mobile entity 20A wishes to invoke a location-aware service, it passes its current position to the corresponding service system 40 along with the service request 51. This approach avoids the need for an infrastructure to provide an external frame of reference; however, cost, size and long-term accuracy concerns currently make such systems unattractive for incorporation into mass-market handheld devices.

FIG. 3 shows two different location-determining methods both involving the use of local, fixed-position, beacons here shown as infra-red beacons IRD though other technologies, such as short-range radio systems (in particular, “Bluetooth” systems) may equally be used. The right hand half of FIG. 3 show a number of independent beacons 55 that continually transmit their individual locations. Mobile entity 20B is arranged to pick up the transmissions from a beacon when sufficiently close, thereby establishing its position to the accuracy of its range of reception. This location data can then be appended to a request 59 made by the mobile entity 20B to a location-aware service available from service system 40. A variation on this arrangement is for the beacons 55 to transmit information which whilst not directly location data, can be used to look up such data (for example, the data may be the Internet home page URL of a store housing the beacon 55 concerned, this home page giving the store location—or at least identity, thereby enabling look-up of location in a directory service).

In the left-hand half of FIG. 3, the IRB beacons 54 are all connected to a network that connects to a location server 57. The beacons 54 transmit a presence signal and when mobile entity 20C is sufficiently close to a beacon to pick up the presence signal, it responds by sending its identity to the beacon. (Thus, in this embodiment, both the beacons 54 and mobile entity 20C can both receive and transmit IR signals whereas beacons 55 only transmit, and mobile entity 20B only receives, IR signals). Upon a beacon 54 receiving a mobile entity's identity, it sends out a message over network 56 to location server 57, this message linking the identity of the mobile entity 20C to the location of the relevant beacon 54. Now when the mobile entity wishes to invoke a location-aware service provided by the service system 40, since it does not know its location it must include it's identity in the service request 58 and rely on the service system 40 to look up the current location of the mobile entity in the location server 57. Because location data is personal and potentially very sensitive, the location server 57 will generally only supply location data to the service system 40 after the latter has produced an authorizing token supplied by the mobile entity 20B in request 58. It will be appreciated that whilst service system 40 is depicted as handling service requests form both types of mobile entity 20 B and 20C, separate systems 40 may be provided for each mobile type (this is likewise true in respect of the service systems depicted in FIGS. 4 and 5).

FIG. 4 depicts several forms of GPS location-determining system. On the left-hand side of FIG. 4, a mobile entity 20D is provided with a standard GPS module and is capable of determining the location of entity 20D by picking up signals from satellites 60. The entity 20D can then supply this location when requesting, in request 61, a location-aware service from service system 40.

The right-hand side of FIG. 4 depicts, in relation to mobile entity 20E, two ways in which assistance can be provided to the entity in deriving location from GPS satellites. Firstly, the PLMN 10 can be provided with fixed GPS receivers 62 that each continuously keep track of the satellites 60 visible from the receiver and pass information in messages 63 to local mobile entities 20E as to where to look for these satellites and estimated signal arrival times; this enables the mobile entities 20E to substantially reduce acquisition time for the satellites and increase accuracy of measurement (see “Geolocation Technology Pinpoints Wireless 911 calls within 15 Feet” Jul. 1, 1999 Lucent Technologies, Bell Labs). Secondly, as an alternative enhancement, the processing load on the mobile entity 20E can be reduced and encoded jitter removed using the services of network entity 64 (in or accessible through PLMN 10).

One the mobile unit 20E has determined its location, it can pass this information in request 65 when invoking a location-aware service provided by service system 40.

FIG. 5 depicts two general approaches to location determination from signals present in a cellular radio infrastructure. First, it can be noted that in general both the mobile entity and the network will know the identity of the cell in which the mobile entity currently resides, this information being provided as part of the normal operation of the system. (Although in a system such as GSM, the network may only store current location to a resolution of a collection of cells known as a “location area” , the actual current cell ID will generally be derivable from monitoring the signals exchanged between the BSC 14 and the mobile entity). Beyond current basic cell ID, it is possible to get a more accurate fix by measuring timing and/or directional parameters between the mobile entity and multiple BTSs 13, these measurement being done either in the network or the mobile entity (see, for example, International Application WO 99/04582 that describes various techniques for effecting location determination in the mobile and WO 99/55114 that describes location determination by the mobile network in response to requests made by location-aware applications to a mobile location center-server-of the mobile network).

The left-hand half of FIG. 5 depicts the case of location determination being done in the mobile entity 20F by, for example, making Observed Time Difference (OTD) measurements with respect to signals from BTSs 13 and calculating location using a knowledge of BTS locations. The location data is subsequently appended to a service request 66 sent to service system 40 in respect of a location-aware service. The calculation load on mobile entity 20F could be reduced and the need for the mobile to know BTS locations avoided, by having a network entity do some of the work. The right-hand half of FIG. 5 depicts the case of location determination being done in the network, for example, by making Timing Advance measurements for three BTSs 13 and using these measurements to derive location (this derivation typically being done in a unit associated with BSC 14). The resultant location data is passed to a location server 67 from where it can be made available to authorised services. As for the mobile entity 20C in FIG. 3, when the mobile entity 20G of FIG. 5 wishes to invoke a location-aware service available on service system 50, it sends a request 69 including an authorisation token and its ID (possible embedded in the token) to the service system 40; the service system then uses the authorisation token to obtain the current location of the mobile entity 20G from the location server 67.

In the above examples, where the mobile entity is responsible for determining location, this will generally be done only at the time the location-aware service is being requested. Where location determination is done by the infrastructure, it may be practical for systems covering only a limited number of users (such as the system illustrated in the left-hand half of FIG. 2 where a number of infrared beacons 54 will cover a generally fairly limited) for location-data collection to be done whenever a mobile entity is newly detected by an IRB, this data being passed to location server 57 where it is cached for use when needed. However, for systems covering large areas with potentially a large number of mobile entities, such as the FIG. 5 system, it is more efficient to effect location determination as and when there is a perceived need to do so; thus, location determination maybe triggered by the location server 67 in response to the service request 68 from the mobile entity 20G or the mobile entity may, immediately prior to making request 68, directly trigger BSC 14 to effect a location determination and feed the result to location server 67.

Further with respect to the location servers 57, 67, whilst access authorisation by location-aware services has been described as being through authorisation tokens supplied by the mobile entities concerned, other authorisation techniques can be used. In particular, a location-aware service can be prior authorised with the location server in respect of particular mobile entities; in this case, each request from the service for location data needs only to establish that the request comes from a service authorised in respect of the mobile entity for which the location data is requested.

As already indicated, FIGS. 2 to 5 depict only some examples of how location determination can be achieved, there being many other possible combinations of technology used and where in the system the location-determining measurements are made and location is calculated, stored and used Thus, the location-aware service may reside in the mobile entity whose location is of interest, in a network-connected service system 40 (as illustrated), or even in another mobile entity. Furthermore, whilst in the examples of FIGS. 2 to 5, invocation of the location-aware service has been by the mobile entity whose location is of interest, the nature of the location-aware service maybe such that it is invoked by another party (including, potentially, the PLMN itself). In this case, unless the invoking party already knows the location of he mobile entity and can pass this information to the location-aware service (which may, for example, may be situation where the PLMN invokes the service), it is the location-aware service that is responsible for obtaining the required location data, either by sending a request to the mobile entity itself or by requesting the data from a location server. Unless the location server already has the needed information in cache, the server proceeds to obtain the data either by interrogating the mobile entity or by triggering infrastructure elements to locate the mobile. For example, where a location-aware service running on service system 40 in FIG. 5 needs to find the location of mobile 20G, it could be arranged to do so by requesting this information from location server 67 which in turn requests the location data from the relevant BSC, the latter then making the necessary determination using measurements from BTSs 13.

Although in the foregoing, the provision of location data through the mobile radio infrastructure to the mobile entity has been treated as a service effected over a data-capable bearer channel, it may be expected that as location data becomes considered a basic element of mobile radio infrastructure services, provision will be made in the relevant mobile radio standards for location data to be passed over a signalling channel to the mobile entity.

It is an object of the present invention to provide an improved security/safety method for equipment operation by using location data.

### SUMMARY OF THE INVENTION

According to one aspect of the present invention, there is provided a control method for enabling particular functionality of an item of equipment upon a set of conditions being satisfied, this set of conditions including both a location condition and a personnel condition, the method involving:

(a) automatically checking the location condition by:

(i) obtaining current-location data representing the current location of the equipment; and

(ii) comparing the current-location data with stored authorized-location data representing a predetermined authorised location or locality for operation of said functionality of the equipment;

(b) automatically checking the personnel condition by checking for the presence at or near the equipment of at least one person fitting stored authorized-personnel data that identifies specified person or persons, or a specified grade of person.

According to another aspect of the present invention, there is provided an equipment control method wherein particular functionality of an item of equipment is enabled upon a set of conditions being satisfied, this set of conditions including a location condition which is tested for by:

(a) obtaining current-location data representing the current location of the equipment;

(b) comparing the current-location data with authorised-location data representing a predetermined authorised location or locality for operation of said functionality of the equipment; and

(c) generating a location-match signal upon the comparison step (b) indicating that the equipment is currently located in said authorised location or locality.

said set of conditions further including a personnel condition that a specified person or persons, or a specified grade of person, must be at or near the equipment, this personnel condition being tested by obtaining location data on the specified person or persons, or on persons meeting said specified grade, and comparing this data either with the current location of the equipment or with said authorized-location data.

The present invention also provides equipment and service systems for use in implementing the foregoing methods

### BRIEF DESCRIPTION OF THE DRAWINGS

A method, equipment and service-system, both embodying the present invention, for condition-based equipment control, will now be described, by way of non-limiting example, with reference to the accompanying diagrammatic drawings, in which:

FIG. 1 is a diagram of a known communications infrastructure usable for transferring voice and data to/from a mobile entity;

FIG. 2 is a diagram illustrating one known approach to determining the location of a mobile entity, this approach involving providing the entity with an inertial positioning system;

FIG. 3 is a diagram illustrating another known approach to determining the location of a mobile entity, this approach being based on proximity of the mobile entity to fixed-position local beacons;

FIG. 4 is a diagram illustrating a further known approach to determining the location of a mobile entity, this approach involving the use of GPS satellites;

FIG. 5 is a diagram illustrating a still further approach to determining the location of a mobile entity, this approach being based on the use of signals present in a cellular mobile radio communications system;

FIG. 6 is a diagram illustrating a first embodiment of the invention; and

FIG. 7 is a diagram illustrating a second embodiment of the invention.

### BEST MODE OF CARRYING OUT THE INVENTION

In certain situations it is desirable to limit the operational capabilities of an item of movable equipment to certain locations—for example, to prevent theft, it would be useful to limit operation of a mechanical digger to the site where is was currently being legitimately employed. However, security and safety considerations may also lead to a requirement that the equipment only be operated when a particular person or grade of personnel (such as a foreman) is present or nearby.

As will be described below, embodiments of the present invention provide ways of testing both that the equipment is at an authorized working location (the ‘location’ condition) and that particular personnel (grade or individuals) is present (the ‘personnel’ condition), the equipment only being enabled when both conditions are satisfied.

The authorized location requirement is tested for by deriving the location of the equipment concerned and comparing it with predetermined authorized-locations data that specifies where the equipment is authorized for use. Current location data about the equipment can be derived by the equipment itself or by a communications infrastructure (e.g. cellular radio network) with which the equipment communicates. As regards the authorised-locations data, this can be:

held in the equipment (and potentially modifiable under password control);

held at a remote server to which the equipment must refer; in this case, a reference identifying what authorised-locations data is relevant must be passed to the server (this reference could identify the equipment or a particular user). The identifying reference may be provided from the equipment itself or from the communications infrastructure if known to the latter.

The comparison of equipment current location and the authorized location data can be effected at the equipment itself or at a remote authorization server; in this latter case, the server returns an authorization code only when the equipment location corresponds to the authorized location data (and subject to any other conditions tested for by the remote system being satisfied).

As regards the requirement that a particular person or grade of person being present at or near the equipment (though not necessarily operating the equipment), data concerning such authorized personnel can be stored either in the equipment or at a remoter service system, in much the same way as for the authorized-location data. The testing for the presence of an authorized person at or near the equipment can be effected either by obtaining location information about authorized personnel and comparing it with the current or authorized location of the equipment (this can be done either at the equipment or at a remote service system provided with the necessary location information), or by a check of personnel in the proximity of the equipment. Whilst generally only one specified personnel will required to be present at or near the equipment for the personnel condition to be satisfied, it is possible to require two or more such personnel to be simultaneously present.

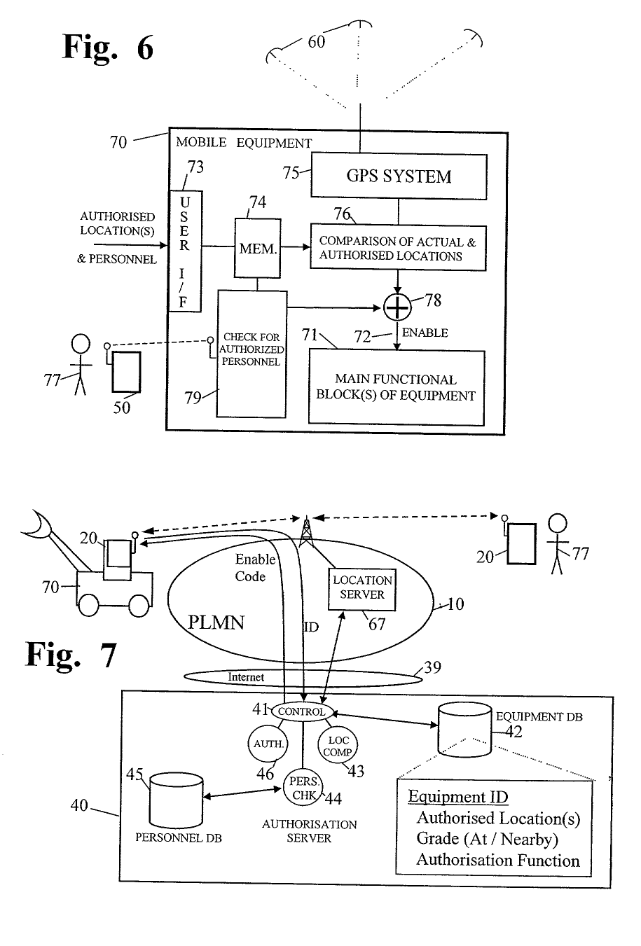

Considering now the first embodiment of the invention shown in FIG. 6, in this embodiment both the authorized location data and the authorized personnel data are stored in the equipment 70 concerned (for example, a mechanical digger) and the location and personnel checks are both carried out at the equipment itself. By way of example, the authorized location is defined as being within a one kilometer radius of a specified point and the authorized personnel are defined by the identities of specific individuals.

The mobile equipment 70 comprises functionality 71 (such as engine management system) that must be enabled by the presence of an enable signal on line 72 for it to function. Authorized location and personnel data is set into the equipment via user interface 73 under password control and is stored in memory 74; if the mobile equipment is provided with remote communication means, such as mobile radio the authorized location and personnel data can be arranged to be updated remotely.

The current location of the equipment 70 is obtained via a GPS system 75. The current location data and the authorized location data are fed to comparison unit 76 which ascertains whether the equipment is located in an authorized location; if it is, unit 76 produces an enabling output which it passes to logical AND function 78.

A personnel check sub-system 79 includes a short-range transceiver (such as a Bluetooth transceiver) by which it can communicate with complementary transceivers 50 carried by persons in the vicinity of the equipment. These transceivers 51 are arranged to return the identity of the person to whom they belong when appropriately interrogated by the sub-system 79. In this manner, the sub-system can ascertain who is close by and can compare the identities of such persons with the list of authorized personnel held in memory 74. If there is a match, sub-system 79 produces an enabling output which it passes to AND function 78.

When AND function 78 receives enabling signals on both inputs it generates an ENABLE output signal to enable operation of functionality 71. In this manner, operation of the equipment is restricted to the location (locality) defined by the input authorized location data and only when an authorized person is present. The checks for authorized location and authorized personnel are preferably carried out at regular intervals, for example, every minute (thus, the AND function output is latched and held for a corresponding period).

When the equipment is moved to a new working location beyond the previously authorized location, all that is needed is for a new authorized location to be entered into memory 72, overwriting the previous data; it would also be possible to set in a set of authorized locations and then to select a currently operative one from the list. It may or may not also be necessary to update the authorized personnel information at the same time.

Where the mobile equipment is a vehicle or some other potentially dangerous equipment, it will generally be prudent to arrange for a graceful performance degradation should the equipment move from the authorized location or away from an authorized person. It is also prudent to provide an override, such as a password-based override, input of the password ensuring that the enable signal is continuously present online 72.

It will be appreciated that other forms of location discovery means could be used for the FIG. 6 embodiment and, indeed, in the embodiment of FIG. 7—which also relates to an item of mobile equipment 70, such as a mechanical digger—current location information on the equipment is obtained through a location server 67 of a PLMN 10, equipment 70 being provided with a cellular radio device 20. Similarly, the check of authorized personnel can be effected by comparing the location of such personnel with the location of the equipment rather than by using the proximity checking method described.

In the FIG. 7 embodiment, the location and personnel checks are effected at a remote service system which also stores the authorized location and personnel data. The operation of the embodiment is as follows. The mobile equipment 70 sends its identity ID to a remote service system (authorisation server 40) via a data-capable bearer service of PLMN 10 and internet 39. A control process 41 at the authorisation server 40 receives the ID and first does a location check by:

obtaining the current location of the mobile equipment from location server 67 of PLMN 10,

obtaining the authorised location for the mobile equipment by interrogating an equipment database 42 using the equipment ID.

The current and authorised locations are then compared (see block 43) and if this produces a positive result, a location-match signal is passed to the control process 41 which then proceeds with checking whether the personnel-related condition is satisfied.

When the process 41 interrogated the database 42 for authorised-location data for mobile equipment 70, it also retrieved data about the required grade of person needed to be at the equipment or in its vicinity (in this case, a foreman 77, for example). A personnel check process 44 now uses this data to identify specific employees of the appropriate grade by referring to database 45 that contains grade/employee information. A location check is then carried out for the candidate employees by an enquiry to location server 67 (employees of interest, such as foreman 77, being equipped with mobile phones 20). The returned location information is then compared against the current location of the mobile equipment or the authorised location of the latter.

Provided sufficiently accurate location information is available, it is possible to selectively require (as identified in the appropriate equipment record of database 42) the specified grade of employee to be present at the mobile equipment or merely in its vicinity.

If both the location and personnel checks are passed, the control process returns an enable code to the mobile equipment 70 to enable its operation. This code may be specific to the equipment and may be time dependent according to a function known to the equipment and to the authorisation server 40. Equipment-specific authorisation code details are held at server 40 in the corresponding equipment record in database 42 and are used by authorisation process 46 to produce the corresponding enable code for sending back via data capable bearer service of PLMN 10 to equipment 70.

The mobile equipment is arranged to periodically require re-enablement from the authorisation server 40.

It will be appreciated that many different embodiments are possible in view of the variety of ways the location information and authorized location and personnel data can be derived. For example, where the presence of an authorized person is checked for by the proximity method described above with reference to FIG. 6, it may still be convenient to use a remote service system to translate equipment identity into the identities of authorized persons, these latter identities being returned to the equipment to enable it to check whether any authorized personnel are nearby.

It will be appreciated that the desired level of security will determine the details of any particular implementation (in particular, various authentication techniques may need to be used to avoid location information being falsified).

The equipment subject to the authorized location and personnel checks need not be portable or mobile equipment though this will normally be the case.

Whilst in the described embodiments the location data has been expressed in terms of absolute location data, it is also possible to use relative location data (as is effectively done regarding the required proximity of foreman 77 in the FIG. 7 embodiment) and also semantic location data (for example, the authorised locations could be specified as all premises of a particular company, in which case there would need to be a translation of this semantic location data to real world locations through, for example, a database that specifies the absolute locations of the company's current premises).

In the described embodiment of FIG. 7, communication with the authorisation server 40 has been via a cellular radio connection. It would, of course, also be possible to used a wired connection (such as a LAN connecting to the Internet) with the current location of the device concerned being obtained by any appropriate manner.

Where a piece of equipment has multiple functional units, it would be possible to locationally limit different functions of the equipment to differing extents.

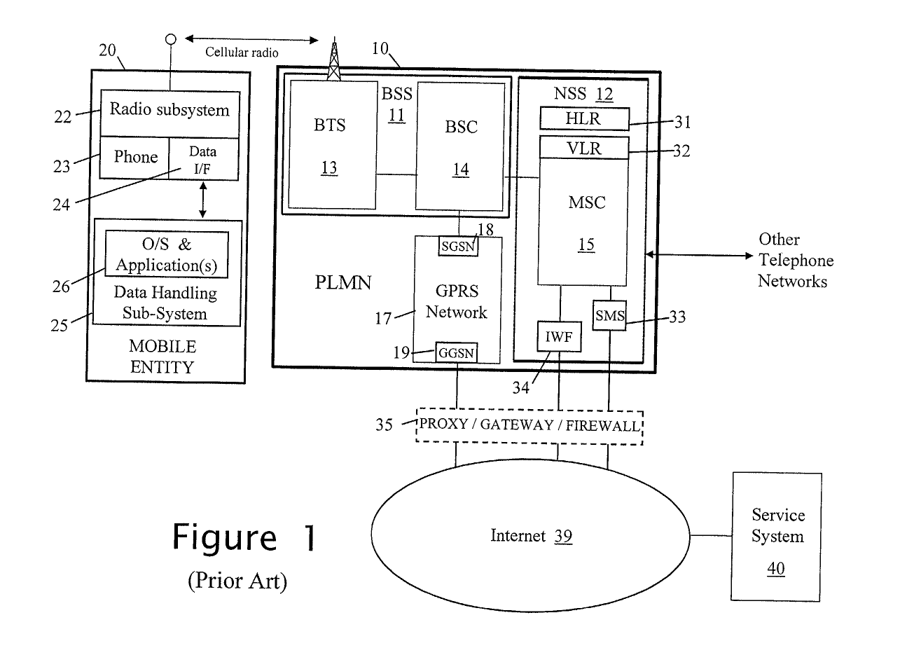

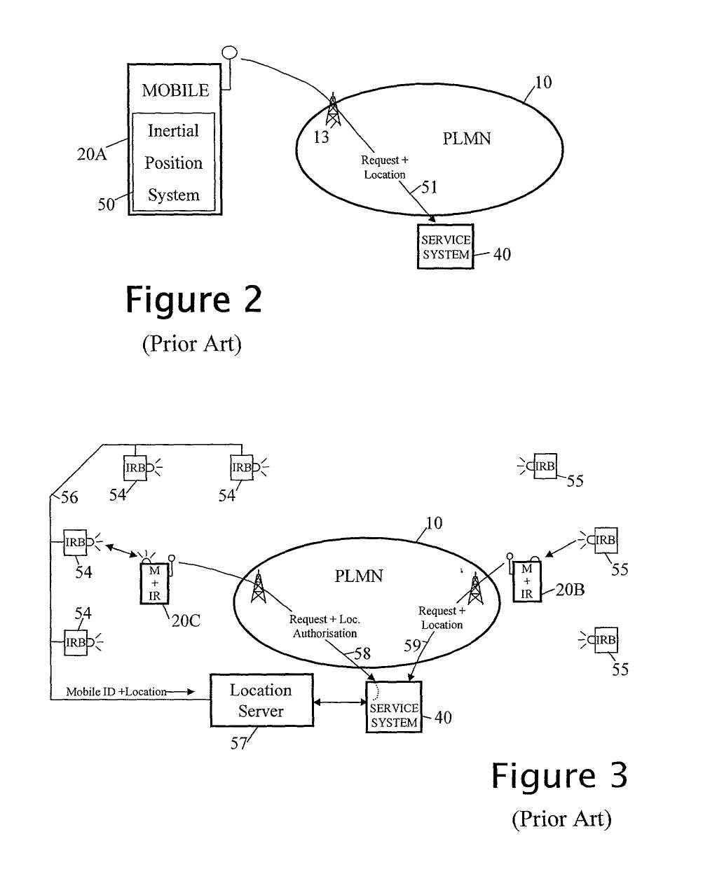

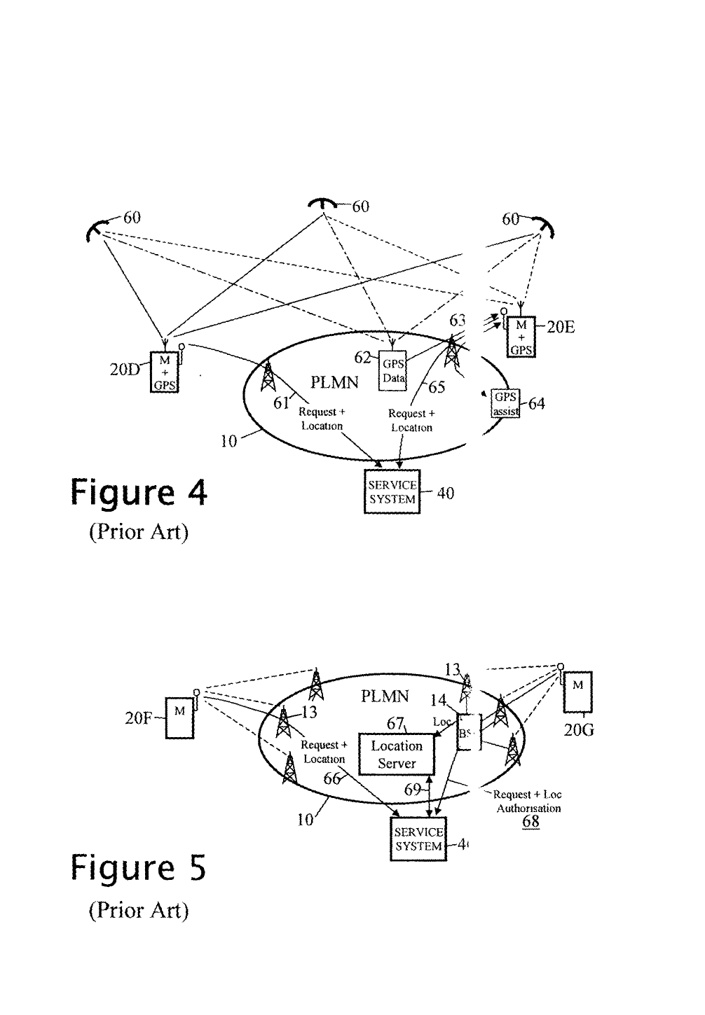

It is to be understood that the present invention is not limited to the specifics of the mobile entity and communication infrastructure and location discovery means shown in FIGS. 6 and 7 and the generalisations discussed above in relation to FIGS. 1 to 5 regarding these elements apply equally to the operational context of the described embodiments of the invention. Furthermore, whilst the service system 40 is shown in FIG. 7 as connected to the public Internet, it could be connected to a GPRS network 17 of PLMN 10 or to another fixed data network interfacing directly or indirectly with the network 17 or network 39.

1. A control method for enabling particular functionality of an item of equipment upon a set of conditions being satisfied, this set of conditions including both a location condition and a personnel condition, the method involving:
(a) automatically checking the location condition by:
(i) obtaining current-location data representing the current location of the equipment; and
(ii) comparing the current-location data with stored authorized-location data representing a predetermined authorised location or locality for operation of said functionality of the equipment;
(b) automatically checking the personnel condition by checking for the presence at or near the equipment of at least one person fitting stored authorized-personnel data that identifies specified person or persons, or a specified grade of person.

2. A method according to claim 1, wherein step (b) is effected by obtaining location data on persons covered by the authorized-personnel data and comparing this data either with the current location of the equipment or with said authorized-location data.

3. A method according to claim 1, wherein step (b) is effected by using a short-range communications system located on the equipment to determine identity information about nearby persons, this identity information then being compared against the authorized-personnel data.

4. A method according to claim 1, wherein the authorised-location data is stored in the equipment itself, the equipment either determining or being passed said current-location data, and sub-step (a)(ii) being carried out at the equipment.

5. A method according to claim 4, wherein the authorised-location data is modifiable by an appropriately authorised person attending at the equipment or remotely over a communications link.

6. A method according to claim 1, wherein the authorised-location data is stored in a remote service system, the equipment having a communication subsystem enabling it to communicate with the service system via a communications infrastructure thereby to receive said authorised-location data and compare it at the equipment with current-location data that the equipment has determined or obtained.

7. A method according to claim 1, wherein the equipment has a communication sub-system enabling it to communicate with a remote service system via a communications infrastructure, the authorised-location data being stored at the equipment and being passed to the service system via the communications infrastructure, and step (a)(ii) being carried out at the remote service system with the current location data being obtained either by the equipment and passed to the service system, or by the service system from separate location discovery system.

8. A method according to claim 7, wherein the communications infrastructure is a cellular radio infrastructure and the communication sub-system of the equipment is a cellular radio device, the infrastructure having a location determining system for determining the location of the cellular radio device and thus of the equipment, and the remote service system obtaining said current-location data from the location determining system directly.

9. A method according to claim 1, wherein the equipment has a communication sub-system enabling it to communicate with a remote service system via a communications infrastructure, the authorised-location data being stored at the service system and being retrieved against equipment identity information received via the communications infrastructure, and step (a)(ii) being carried out at the remote service system with the current location data being obtained either by the equipment and passed to the service system, or by the service system from separate location discovery system.

10. A method according to claim 9, wherein the communications infrastructure is a cellular radio infrastructure and the communication sub-system of the equipment is a cellular radio device, the infrastructure having a location determining system for determining the location of the cellular radio device and thus of the equipment, and the remote service system obtaining said current-location data from the location determining system directly.

11. A method according to claim 1, wherein the authorised- personnel data is stored in the equipment itself, and step (b) is carried out at the equipment.

12. A method according to claim 11, wherein the authorised-personnel data is modifiable by an appropriately authorised person attending at the equipment or remotely over a communications link.

13. A method according to claim 1, wherein the authorised-personnel data is stored in a remote service system, the equipment having a communication subsystem enabling it to communicate with the service system via a communications infrastructure thereby to receive said authorised-personnel data and carry out step (b) at the equipment.

14. A method according to claim 2, wherein the equipment has a communication subsystem enabling it to communicate with a remote service system via a communications infrastructure, the authorised-personnel data being stored at the equipment and being passed to the service system via the communications infrastructure, and step (b) being carried out at the remote service system with location information about authorized personnel being obtained by the service system from a location discovery system.

15. A method according to claim 14, wherein the communications infrastructure is a cellular radio infrastructure and authorised personnel are provided with respective associated cellular radio devices, the infrastructure having a location determining system for determining the location of the cellular radio devices and thus of the authorized personnel, and the remote service system carrying out step (b) by obtaining said current-location data from the location determining system.

16. A method according to claim 1, wherein the equipment has a communication subsystem enabling it to communicate with a remote service system via a communications infrastructure, the authorised-personnel data being stored at the service system and being retrieved against equipment identity information received via the communications infrastructure, and step (b) being carried out at the remote service system with location information about authorized personnel being obtained by the service system from a location discovery system.

17. A method according to claim 16, wherein the communications infrastructure is a cellular radio infrastructure and authorised personnel are provided with respective associated cellular radio devices, the infrastructure having a location determining system for determining the location of the cellular radio devices and thus of the authorized personnel, and the remote service system carrying out step (b) by obtaining said current-location data from the location determining system.

18. A method according to claim 2, wherein the equipment has a communication subsystem enabling it to communicate with a remote service system via a communications infrastructure, the authorised-location data and authorized-personnel data being stored at the service system and being retrieved against equipment identity information received via the communications infrastructure, and steps (a)(ii) and (b) being carried out at the remote service system.

19. A method according to claim 18, wherein the communications infrastructure is a cellular radio infrastructure and authorised personnel are provided with respective associated cellular radio devices, the communication sub-system of the equipment also being a cellular radio device, and the infrastructure having a location determining system for determining the location of the cellular radio devices and thus of the equipment and of authorized personnel, and the remote service system carrying out step (b) by obtaining said current-location data and location information about authorized personnel from the location determining system.

20. An equipment control method wherein particular functionality of an item of equipment is enabled upon a set of conditions being satisfied, this set of conditions including a location condition which is tested for by:
(a) obtaining current-location data representing the current location of the equipment;
(b) comparing the current-location data with authorised-location data representing a predetermined authorised location or locality for operation of said functionality of the equipment; and
(c) generating a location-match signal upon the comparison step (b) indicating that the equipment is currently located in said authorised location or locality.
said set of conditions further including a personnel condition that a specified person or persons, or a specified grade of person, must be at or near the equipment, this personnel condition being tested by obtaining location data on the specified person or persons, or on persons meeting said specified grade, and comparing this data either with the current location of the equipment or with said authorized-location data.

21. Equipment including particular functionality and a control sub-system for enabling said particular functionality upon both a location condition and a personnel condition being satisfied, the control sub-system comprising:
a first condition-check arrangement for determining whether the current location of the equipment matches an authorized location or locality for operation of said functionality that is specified in authorized-location data, the authorized-location data being either held locally in the equipment or received at the equipment from a remote service system;
a second condition-check arrangement for determining whether any persons at or near the equipment is amongst persons that are specified individually or by grade in authorized-personnel data and of which at least one is required to be present at or near the equipment for operation of said functionality, the authorized-personnel data being either held locally in the equipment or received at the equipment from a remote service system; and
an arrangement for enabling said functionality when both the location and personnel conditions are found satisfied by said first and second condition-check arrangements.

22. Equipment including particular functionality and a control sub-system for enabling said particular functionality upon both a location condition and a personnel condition being satisfied, the control sub-system comprising:
a store for holding authorized-location data representing a predetermined authorized location or locality for operation of said functionality,
a communication arrangement for passing the authorized-location data to a remote service system to enable the latter to check whether said location condition is satisfied by the current location of the equipment, the communication arrangement being operative to receive back the result of this condition check;
a condition-check arrangement for determining whether any persons at or near the equipment is amongst persons that are specified individually or by grade in authorized-personnel data and of which at least one is required to be present at or near the equipment for operation of said functionality, the authorized-personnel data being either held locally in the equipment or received at the equipment from the remote service system; and
an arrangement for enabling said functionality when both the location condition is indicated as satisfied by said result passed back from the service system, and the personnel condition is found satisfied by said condition-check arrangement.

23. Equipment including particular functionality and a control sub-system for enabling said particular functionality upon both a location condition and a personnel condition being satisfied, the control sub-system comprising:
a store for holding authorized-personnel data that identifies specified person or persons, or a specified grade of person at least one of which is required to be present at or near the equipment for operation of said functionality;
a communication arrangement for passing the authorized-personnel data to a remote service system to enable the latter to check whether personnel condition is satisfied by the persons currently at or near the equipment, the communication arrangement being operative to receive back the result of this condition check;
a condition-check arrangement for determining whether the current location of the equipment matches an authorized location or locality for operation of said functionality that is specified in authorized-location data, the authorized-location data being either held locally in the equipment or received at the equipment from the remote service system; and
an arrangement for enabling said functionality when both the location condition is found satisfied by said condition-check arrangement, and the personnel condition is indicated as satisfied by said result passed back from the service system.

24. Equipment including particular functionality and a control sub-system for enabling said particular functionality upon both a location condition and a personnel condition being satisfied, the control sub-system comprising
a store for holding both authorized-location data representing a predetermined authorised location or locality for operation of said functionality, and authorized-personnel data that identifies specified person or persons, or a specified grade of person at least one of which is required to be present at or near the equipment for operation of said functionality;
a communication arrangement for passing the authorized-location data and authorized-personnel data to a remote service system to enable the latter to check whether said location and personnel conditions are satisfied by the current location of the equipment and the persons at or near the equipment, the communication arrangement being operative to receive back the result of the condition checks;
an arrangement for enabling said functionality when said result indicates both conditions are satisfied.

25. A service system for use in an equipment control method in which both a location condition and a personnel condition are required to be satisfied for particular functionality of an item of equipment to be enabled, the service system comprising:
a communication sub-system for communicating with the equipment;
a first condition-check arrangement for determining whether the current location of the equipment matches an authorized location or locality for operation of said functionality that is specified in authorized-location data, the authorized-location data being either held locally in the service system or received from the equipment via the communication sub-system;
a second condition-check arrangement for determining whether any persons at or near the equipment is amongst persons that are specified individually or by grade in authorized-personnel data and of which at least one is required to be present at or near the equipment for operation of said functionality, the authorized-personnel data being either held locally in the service system or received from the equipment via the communication sub-system; and
an arrangement for passing an enable signal to the equipment via the communication sub-system when both the location and personnel conditions are found satisfied by said first and second condition-check arrangements.

26. A service system for use in an equipment control method in which both a location condition and a personnel condition are required to be satisfied for particular functionality of an item of equipment to be enabled, the service system comprising:
a communication sub-system for communicating with the equipment;
a store for holding authorized-location data representing a predetermined authorized location or locality for operation of said functionality,
a retrieval arrangement responsive to a communication received from the equipment via the communication sub-system, to retrieve the authorized-location data from the store and return it to the equipment to enable the latter to check whether said location condition is satisfied by the current location of the equipment;
a condition-check arrangement for determining whether any persons at or near the equipment is amongst persons that are specified individually or by grade in authorized-personnel data and of which at least one is required to be present at or near the equipment for operation of said functionality, the authorized-personnel data being either held locally in the service system or received from the equipment via the communication sub-system, and the condition-check arrangement being operative to return the result of this condition check to the equipment via the communication sub-system.

27. A service system for use in an equipment control method in which both a location condition and a personnel condition are required to be satisfied for particular functionality of an item of equipment to be enabled, the service system comprising:
a communication sub-system for communicating with the equipment;
a store for holding authorized-personnel data that identifies specified person or persons, or a specified grade of person at least one of which is required to be present at or near the equipment for operation of said functionality;
a retrieval arrangement responsive to a communication received from the equipment via the communication sub-system, to retrieve the authorized-personnel data from the store and return it to the equipment to enable the latter to check whether said personnel condition is satisfied by persons currently at or near the equipment;
a condition-check arrangement for determining whether the current location of the equipment matches an authorized location or locality for operation of said functionality that is specified in authorized-location data, the authorized-location data being either held locally in the service system or received from the equipment via the communication sub-system; and the condition-check arrangement being operative to return the result of this condition check to the equipment via the communication sub-system.

28. A service system for use in an equipment control method in which both a location condition and a personnel condition are required to be satisfied for particular functionality of an item of equipment to be enabled, the service system comprising:
a communication sub-system for communicating with the equipment;
a store for holding both authorized-location data representing a predetermined authorized location or locality for operation of said functionality, and authorized-personnel data that identifies specified person or persons, or a specified grade of person at least one of which is required to be present at or near the equipment for operation of said functionality; and
a retrieval arrangement responsive to a communication received from the equipment via the communication sub-system, to retrieve the authorized-location data and the authorized-personnel data from the store and return them to the equipment to enable the latter to check whether said location and personnel conditions are satisfied by the current location of the equipment and the persons currently at or near the equipment.
